(19) United States
(12) Patent Application Publication
(10) Pub. No.: US 2006/0277203 A1
(43) Pub. Date: Dec. 7, 2006

(54) Method of providing tree-structured views of data

(76) Inventor: Frank Uittenbogaard, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/570,433

(22) PCT Filed: Aug. 27, 2004
(86) PCT No.: PCT/IB04/51588

§ 371 Date: Mar. 2, 2006

(30) Foreign Application Priority Data
Sep. 9, 2003 (EP) 03103327.7

(51) Int. Cl. G06F 7/00

(52) U.S. Cl. 707/100

(57) ABSTRACT

This invention relates to a method of enabling a user of a database to define a tree view representation of data items in a database. The data items in the database relate to object types and attributes. An attribute can be a basic attribute or a link attribute, where basic attributes contain general information regarding the object type to which it is related and wherein the concept of link attributes is provided by this invention. A link attribute is relating one object type to one or more other object types and provides the possibility of enabling a user to define a required representation of the data items in the database in a tree structure. The invention enables a user to choose the root of the tree structure and to define recursive database views.

This invention relates to a method of providing a tree structured view on data items in a data base, which data items each are related to one or more object types, where each object type has any number of attributes.

Tree structured view or tree structures are widely used in all kinds of software applications. Examples are directory structures in file managers, menu systems comprising submenus, content organization in on-line documentation, etc. When tree structures are to be presented to a user, they are often represented as an indented list, starting with a non-indented root element (e.g. the main directory) on a first line followed by indented sub-elements each on a separate succeeding line. Each sub-element can have further sub-elements, which are shown just below the sub-element concerned at a next level of indentation.

Often, a user can expand or collapse individual elements to uncover or hide sub-elements of a particular (sub-) element. “Selecting” an element at any level often has some specific effect, e.g. in a file manager selecting a (sub) directory may cause displaying the files it contains in a separate window. Sometimes, selection of an element causes its expansion or another effect dependent on whether it has sub-elements. For example, selection of a menu item may cause displaying a submenu, or if there is no submenu, the invoking of a corresponding function.

The known tree-structures are generally predefined and use a predetermined subordination relation between objects in the tree. For example, most file managers are based on the concept of directories and subdirectories, and this subordination relation is visualized by means of a tree representation. Such trees may have an indefinite number of levels. More complex systems, such as hierarchical database systems, allow multiple object types in one tree structure, e.g. student data, course enrolment data subordinate to student data, and examination data subordinate to course enrolment data. Another example might be patient data, test data subordinate to patient data. . . . With these systems the data model used prescribes how the tree structures are defined and visualized to the user. The tree structures often have a fixed maximum depth, and users have only little influence on their definitions, typically the only options are to expand or collapse certain levels in the tree structure.

In modern, i.e. semantic or object oriented, database systems, complex relationships may exist between multiple object types, many of which relationships normally would not classify as subordinations relationships. This is in particular true for 1 :1 and n:m relationships (in that I :n relationships often, but not always, suggest some form of hierarchical organization of the object types). Still, a tree structure may be very useful to visualize such complex relationships to enable a user to explore and understand them.

In for instance a company database, it may be useful to produce a tree structure representation of the department objects or of project objects. Such view is typically hard coded in the application on top of the database system. Such coding is costly and time consuming and it is impossible to foresee all possible user needs. The resulting system thus offers little flexibility to the end user and new user needs have to be implemented by a database manager, typically an IT professional.

U.S. Pat. No. 6,341,280 B1 discloses an inline tree filter arranged to give a user defined view of a tree structure, where the inline tree filter can be applied to a traditional interface element, such as a hierarchical tree viewer. U.S. Pat. No. 6,341,280 B1 describes the provision of a technique that enables the user to choose selectively the data that he/she wishes to display, while not otherwise altering the behaviour and interaction of the tree viewer. However, the tree structure is fixed, and the filtering mechanism works to provide a filtered view of a selected part of the contents of the fixed tree structure. Even though this filtering could include removing or adding children nodes to the tree structure, U.S. Pat. No. 6,341,280 B1 does not provide a method of defining the tree structure itself.

It is therefore an object of the present invention to provide a method of the kind mentioned in the introduction, which method allows a user to define tree view representations.

This object is achieved when the method comprises the steps of representing at least one relationship between any object type and other object types related thereto in the data base as a link attribute, which link attribute is expandable, i.e. is related to an object type having one or more further attributes; presenting an object type and its attribute(s); providing the user with the possibility to expand any link attribute, so that one or more further attribute(s) of the object type related to the expanded link attribute(s) is (are) presented; providing the user with the possibility to define a view of data on the basis of the presented attribute(s); and displaying the data items related to attribute(s) in the user defined view of data.

Hereby, the user is not constrained to view data items in a database in a fixed structure, but can define a tree view representation of data items to be displayed. This also facilitates the work of data base managers, who no longer will have to attempt to foresee the user needs regarding display of data items.

One way of providing the user with the possibility to expand any link attribute is to display the link attribute in a manner which differs from the displaying of other kinds of attributes, and facilitating the expansion of the link attribute by clicking on the link attribute by means of a pointing device, such as a mouse.

One way of providing the user with the possibility to expand any link attribute is by enabling him/her to mark certain attribute(s) among the presented attribute(s), which certain attribute(s) relate to the data items to be shown. This possibility could e.g. be provided by means of checkboxes.

It should be noted that the term attribute includes basic attributes and link attributes, whereof basic attributes contain general information regarding the object type to which it is related and link attributes are relating one object type to one or more other object types. Examples of basic attributes could be “Name” and “Age”, and a link attribute of an object type “Person” might refer to the object type “Department” in the company the person is employed in. Whenever the term ‘attribute’ is used herein, it is meant to cover both basic and link attributes.

In a preferable embodiment of the method according to the invention, the method further comprises the step of providing the user with the possibility to select an object type to be presented as the root of the tree structured view. This provides a truly user definable view of data items in a data base.

According to a preferred embodiment of the method according to the invention further comprises the step of displaying the attributes of an object type in an indented view. This gives a clear overview of the data items displayed.

According to yet a preferred embodiment of the method according to the invention, the data items related to the attribute(s) are presented in a first part of a screen and the attribute(s) is (are) presented to the user on a second part of the screen. This facilitates the selection by the user of object types containing data items to be displayed and facilitates a well-arranged display of the data items.

Preferably, the method according to the invention is executed by use of a database model of the database.

Preferably, the method according to the invention is performed in a personal computer, a personal digital assistant, a set-top box or in a television. The displaying of the data takes place on a screen of the respective apparatus.

In a preferred embodiment the method according to the invention further comprises the step of providing the user with the possibility of defining a recursive view by marking a cyclic path through one or more link attributes. Hereby, a user can define a recursive view of data items.

The invention will be explained more fully below in connection with a preferred embodiment and with reference to the drawing, in which:

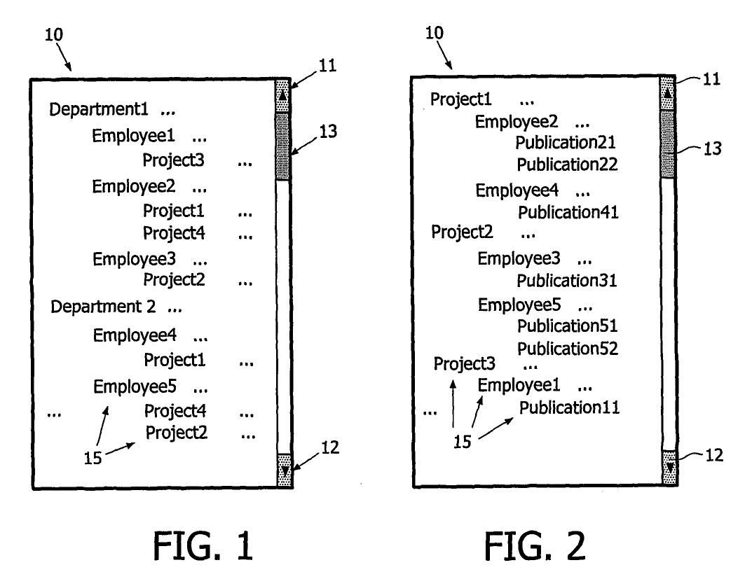

FIGS. 1 and 2 show traditional tree structure representations;

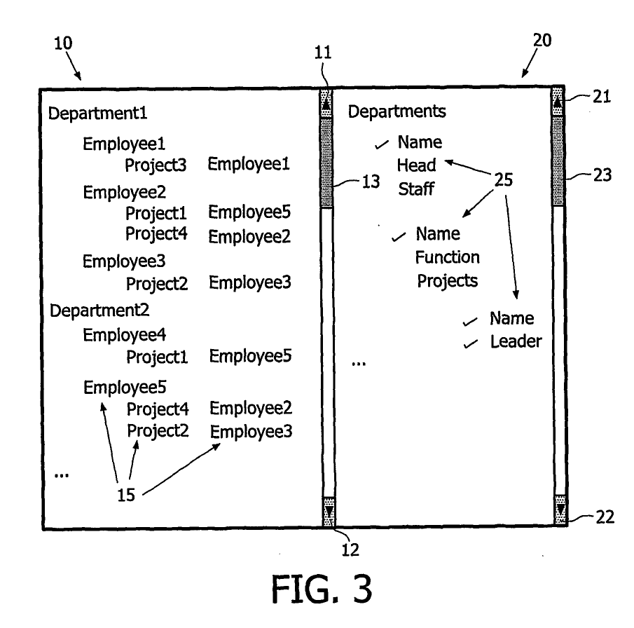

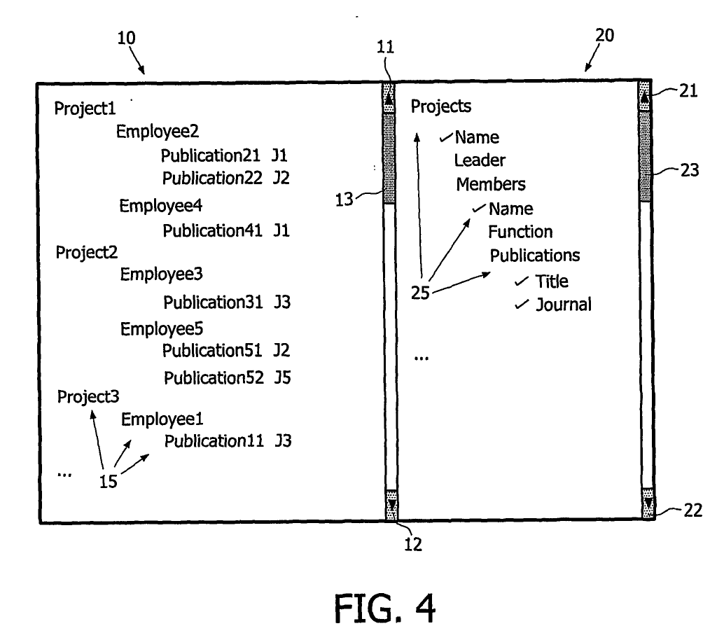

FIGS. 3 and 4 show examples for defining a database view according to the invention;

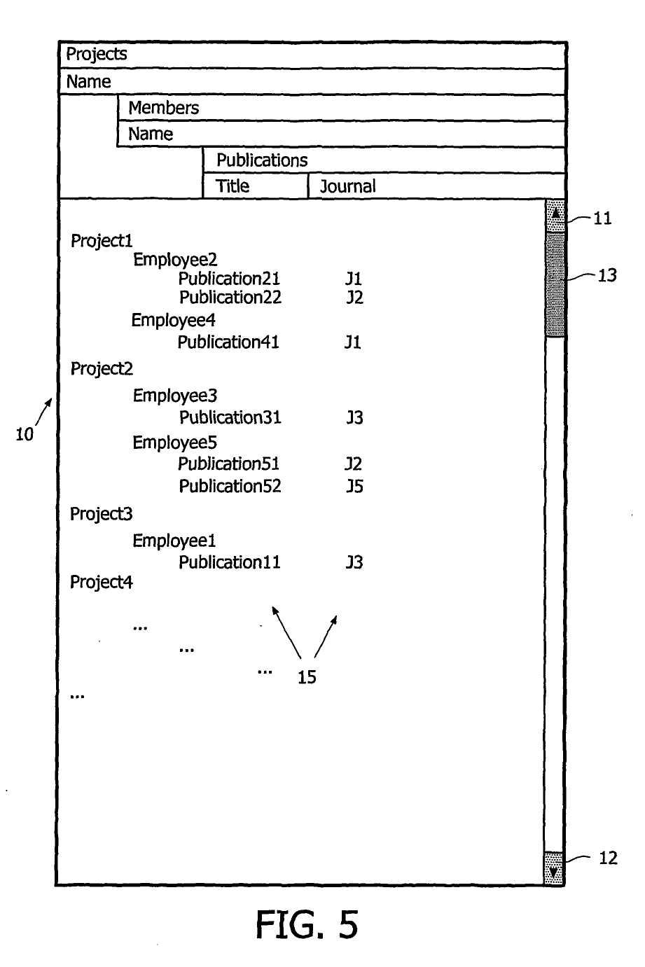

FIG. 5 shows a data panel of a database view according to the invention;

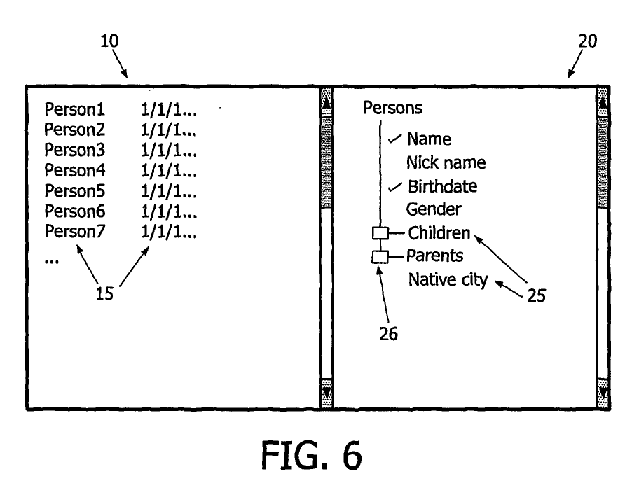

FIGS. 6 to 9 show examples for defining recursive database views according to the invention;

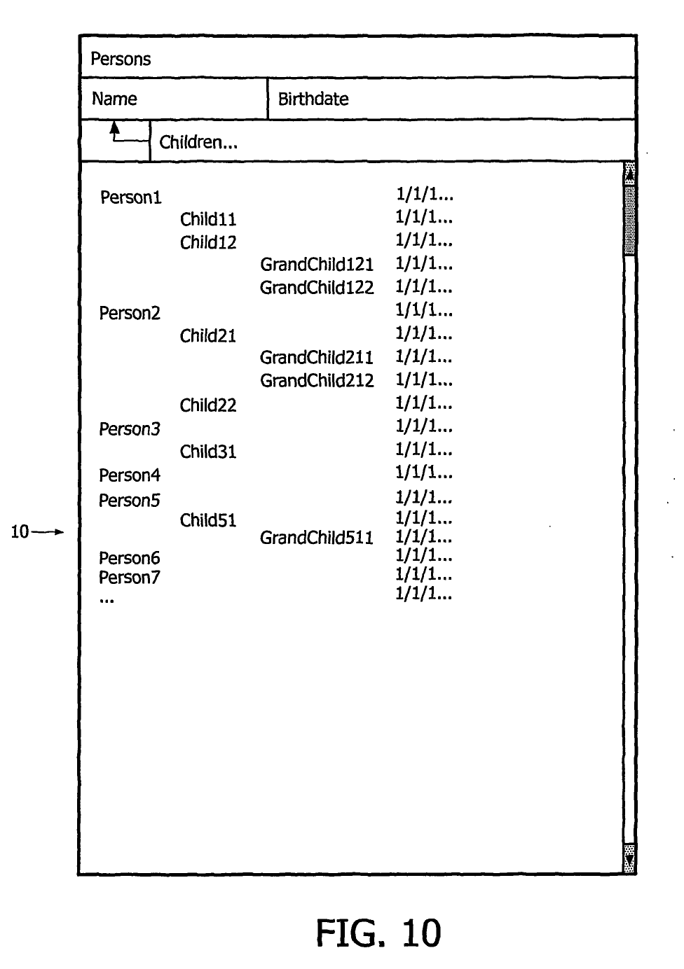

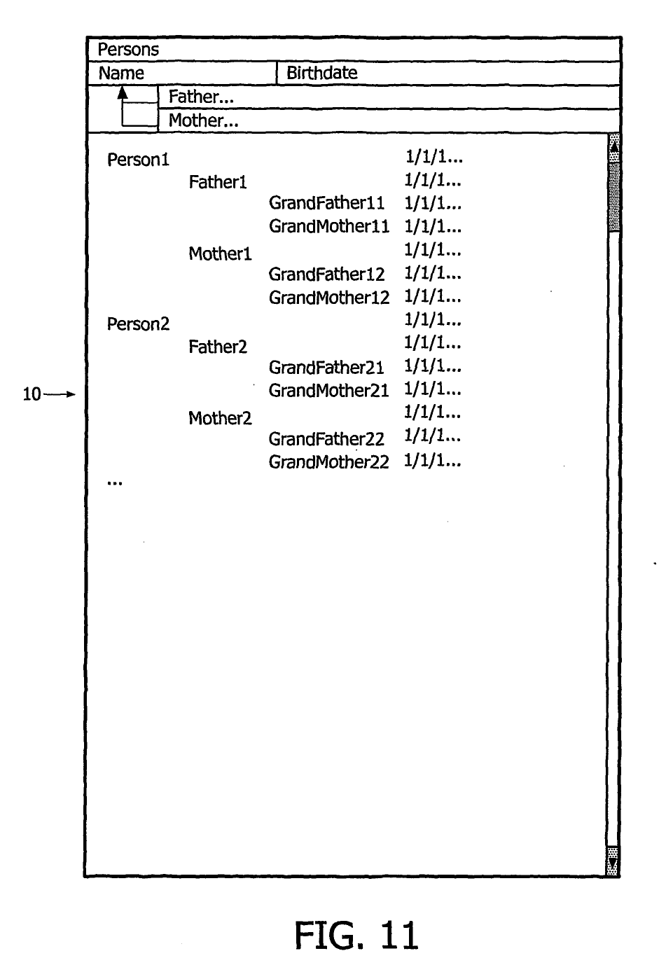

FIGS. 10 and 11 show further examples of a data panel of a database view according to the invention; and

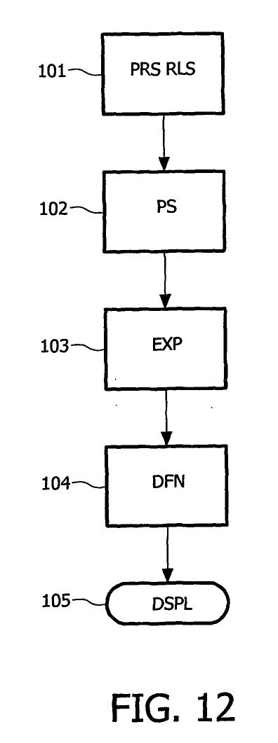

FIG. 12 is a flow chart showing the steps of the method according to the invention.

Throughout this description, like reference numerals refer to like elements.

FIGS. 1 and 2 show traditional tree structure representations of data items on a display or screen 10. The display or screen 10 can be the display or a part thereof of any suitable electronic unit, such as for instance a personal computer, a personal digital assistant, a set-top box or a television. Text 15 is shown in the display 10, arranged in a tree structure representation. The text 15 in FIGS. 1 and 2 is an example of a representation of department objects in a company database. In FIG. 1, the root nodes represent names of departments in the company; in FIG. 2 the root nodes represent project objects instead. In FIGS. 1 and 2, only imaginary names of departments, projects and employees are shown, but naturally other properties could be presented as well, which is indicated by “. . . ”. The structure of such view is typically hard coded in the application on top of the database system, so that a user has only little influence in defining the view to be displayed. The screen or display 10 or part thereof shown in FIGS. 1 and 2, contains means 11, 12, 13 for navigating, e.g. scrolling up and down, in the text 15 shown.

FIGS. 3 and 4 show examples for defining a company database view according to the invention. FIG. 3 and 4, respectively, shows an example for defining the database view shown in FIG. 1 and 2, respectively. FIG. 3 shows a display or screen or part thereof containing two panels 10, 20: a data panel 10, shown to the left, for presenting the actual data items as text 15, and a view panel 20, shown to the right, for enabling the user to define the desired view on the data items. The size and layout of the panels 10, 20 are just exemplary and are not meant to limit the scope of the invention. In FIG. 3, the view panel 20 shows object types and attributes as text 25, e.g. “Departments” as a root object type, with attributes “Name”, “Head” and “Staff”, which attributes are shown indented in relation to the root object type “Departments”. The attribute “Name” has been checked for presentation (which is indicated in FIG. 3 by the symbol “√”), so that the names of the departments, e.g. the data items in the object type “Departments”, are shown in the data panel 10. The attributes “Head” and “Staff” are unchecked. The data items in the object type “Department” are shown as the non-indented text “Department1”, “Department2” in the data panel 10. In the view panel 20, the attribute “Staff” is a link attribute, which has been expanded to show the attributes “Name”, “Function” and “Projects” in the view panel 20 of FIG. 3. In the view panel, the attribute “Name” related to the link attribute “Staff” has been checked for presentation, so that the names of the data items in the link attribute “Staff” is shown in the data panel 10, indicated by “Employee1”, “Employee2”, etc. in the data panel 10. The attributes “Function” and “Projects” in the view panel are unchecked, but the link attribute “Projects” has been expanded to show attributes of the related object type indented, i.e. “Name” and “Leader”. Both of these latter attributes has been checked for presentation, the data items thereof shown indented in the data panel 10, as “Project3”, “Project1”, etc., and “Employee1”, “Employee5”, “Employee2”, etc., respectively.

FIG. 4 shows an example for defining a company database view according to the invention similar to FIG. 3. However, in FIG. 4 the root node in the view panel 20 is “Projects” instead of “Departments” in FIG. 3, so that the data displayed in the data panel 10 corresponds to the data displayed in FIG. 2, whereas the data displayed in the data panel 10 in FIG. 3 corresponds to the data displayed in FIG. 1. In FIG. 3 and 4 are also shown means 11, 12, 13, 21, 22, 23 for navigating in the panels 10, 20. However, these means are not part of the invention and will not be described in further detail.

FIG. 5 shows a data panel 10 of a database view according to the invention. The data panel 10 comprises data items represented as text 15 and is arranged with headers, which are subdivided into three levels, each consisting of two lines, whereof the first line indicates a link attribute linking the level with the previous level, and the second line indicates the attributes, the relevant data items of which are actually presented in the data panel 10. The table headers in FIG. 5 serve as further communication to the user regarding how the tree is defined (using the view panel 20 which is not shown in FIG. 5). The user might have some limited control in the header section (e.g. to remove a level or recursion), but this section lacks the full functionality of the view panel (e.g. a listing of all the available attributes) to be able to create a completely user defined database view.

FIGS. 6 to 9 show further alternative examples for defining database views according to the invention. In the examples described so far, the tree structures have a fixed number of levels. However, in many applications, such as directory structures, etc., tree structures can have an indefinite depth. The invention provides an elegant way of defining such so-called recursive views on a database. FIG. 6 shows a data panel 10 and a view panel 20 in response to a user having indicated that (s)he wants to define a recursive view, e.g. on a genealogical database. In the view panel 20, the user can establish a connection between one link attribute and a higher level, e.g. the root or an earlier link attribute. A possible way of providing the user with this possibility is by providing checkboxes 26 as depicted in FIG. 6. These checkboxes 26 are only displayed in the view panel 20 when a recursion via a link attribute is possible. In the example, recursion is possible through the link attributes “Children” and “Parents” but not through the link attribute “Native city”. When checked, a checkbox closes a connection between the corresponding link attribute and the earlier level. Instead of checkboxes any other means for connecting two levels may be applied, e.g. drawing a line between them, dragging one to the other, etc.

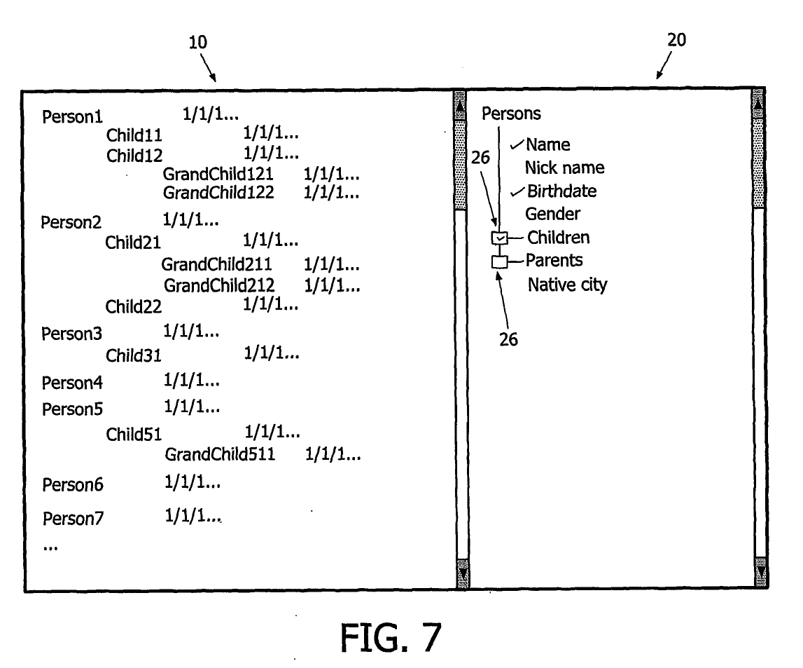

In the view panel 20 in FIG. 6, none of the two check boxes 26, related to “Children” and “Parents”, respectively, have been checked, so that the data panel does not display a recursive view. The attributes “Name” and “Birth date” have been checked, resulting in the displaying of the names “Person1”, “Person2”, etc. and the respective birthdates, indicated by “1/1/1 . . . ” in the data panel 10. In FIG. 7, the attributes “Name” and “Birth date” have been checked again, resulting again in the displaying of the names “Person1”, “Person2”, etc. and the respective birthdates, indicated by “1/1/1 . . . ” in the data panel 10. Moreover, the checkbox for “Children” in the view panel 20 has been checked, resulting in the recursive view shown in the data panel 10, where the display of “Name” and “Birth date” is applied to all the children and the grandchildren of the persons in the root “Persons”. Each level is presented with a proportional indentation.

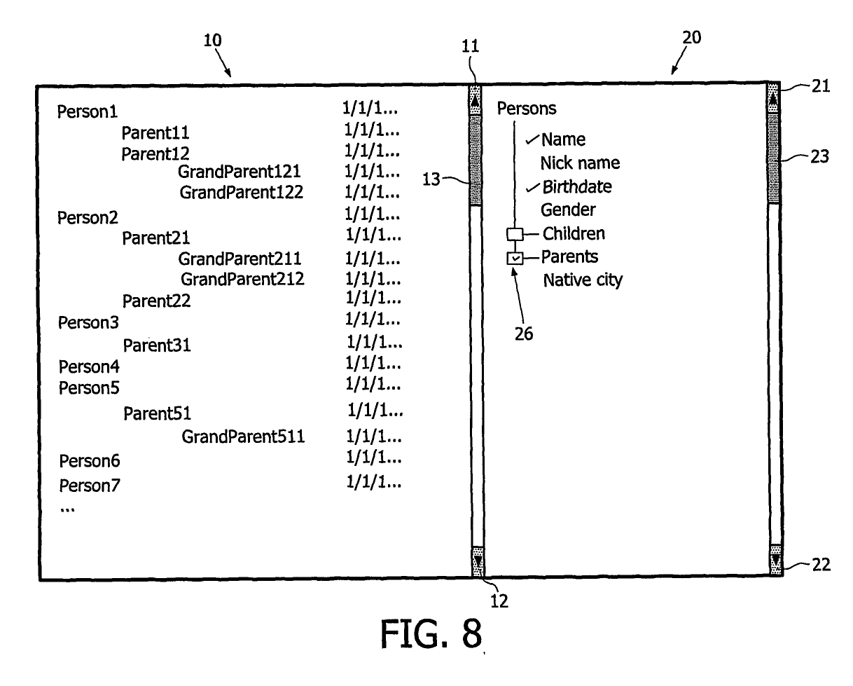

FIG. 8 is similar to FIG. 7 apart from the fact that in the data panel 20 of FIG. 8, the check box “Parents” has been checked instead of the check box “Children” in FIG. 7. This gives a recursion view via the attribute “Parents”, with a slight variation in that only the text relation to the data items related to the attribute “Name” has differing indentation, whereas the properties related to the attribute “Birth date” are presented with the same indentation in all lines. This might be more convenient to the user and is shown as an example only; it's a matter of application design and would preferably be user adjustable. The two opposite database views in FIGS. 7 and 8, whereof one is going forward and the other backward in time, can be obtained by only one click of a mouse.

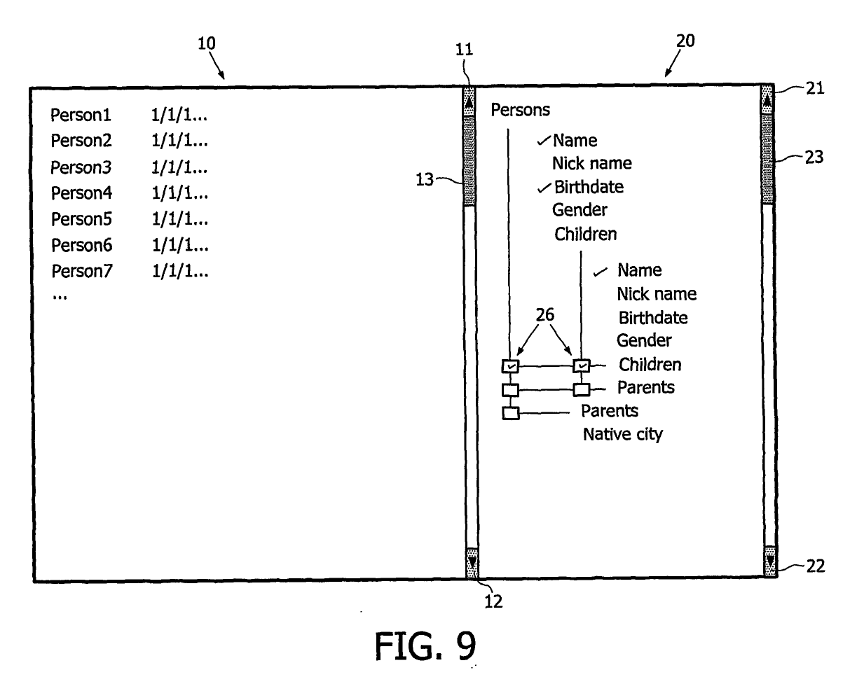

The user may also choose to first expand a link attribute before defining a recursive view, which is depicted in FIG. 9. Hereby, the user can define different views for different levels in the tree structure. By checking the appropriate checkbox, the user may for example choose to show the attribute “Birth date” only at the highest level, alternately show and hide levels, show gender for each level except for the highest one, etc. Furthermore, indentation may be set for each level independently; different sorting and/or filtering may be applied to different levels (such as only the ‘female gender line’), etc. Once expanded, a link attribute is no candidate for recursion anymore, since the view on the data items it contains is now determined by the earlier view higher in the loop.

It's also possible to define recursion views via one link attribute while another link attribute at the same or higher level is expanded. Checking the checkbox in FIG. 9 relating to the attribute “Parents” at the highest level (i.e. the lowest checkbox), causes presentation of a tree of mini-trees of parents and their children, grandparents and their children, etc., in an indented representation. Although the user can adjust the indentations separately, this feature may be suppressed, in that the two intermingling indentations might be confusing (e.g. by not showing the lowest checkbox).

FIGS. 10 and 11 show further examples of a data panel 10 of a database view according to the invention. FIG. 10 shows a possible way of indicating the recursive tree structure in the header section of the data panel 10.

Moreover, it is possible to define two or more recursions simultaneously. If for example the parents of a person were not represented by means of the attribute “Parents” but via two distinct attributes, “Father” and “Mother”, a user could check them both, causing a full family tree to be presented, which is shown in FIG. 11.

It should be noted that the checking of checkboxes and marking of attributes to be displayed, expanded and/or displayed in a recursive view could be performed by any suitable means, such as a pointing device, e.g. a mouse, a cursor, a touch on a touch screen, etc.

FIG. 12 is a flow chart showing the steps of the method according to the invention. The method is performed on a database model of a database, in that structure of a database per se is fixed. The database can be any type of database, e.g. an object oriented or relational database. The flow starts in step 101, wherein each relationship between an object type and other object types related thereto in the database is represented as a link attribute.

Next, step 102, an object type and its attribute(s) are presented to the user, typically on a screen or display of an electronic device. Each link attribute can be expandable, which means that is contains one or more further attributes of the object type related to the link attribute. For instance a check box can indicate that a link attribute is expandable, or presenting the name of the link attribute as a hyperlink, but of course any other appropriate means can be used to indicate this.

In step 103 the user is allowed to expand any link attribute, for instance by providing check boxes to be checked by the user. In step 104, the user is allowed to define the view of data, (s)he wishes to see. This can be achieved by allowing the user to mark which attributes contains data items to be displayed. In a preferred embodiment, the method is performed in an electronic device with a display or screen, such as a personal computer, a personal digital assistant a set-top box or a television, and preferably the method according to the invention provides information in two distinct parts of the display or screen: one part is a data panel, wherein the data is displayed, and the other part is a view panel, wherein the attributes are shown. In the view panel the user can define the required view of data items, which is shown in the data panel in a well-arranged manner, step 105.

As noted above, the method according to the invention can be used with any type of database. In relational databases, an object type corresponds to a table, i.e. a record type, while attributes correspond to the table columns. A singular link attribute, i.e. an attribute referring to at most one object, may be straightforwardly defined to represent a table column which contains foreign keys of another table. A plural link attribute, i.e. an attribute referring to a set of objects, does not have a direct counterpart in the relational model. A plural link attribute may be defined for a table of which the primary key occurs as foreign key in another table. Effectively, a virtual column is added whose fields may contain multiple foreign keys. Plural link attributes may also be defined to represent relationships between three or more tables, for example if one of the tables is an auxiliary table to establish an m:n relationship.

1. A method of providing a tree structured view on data items in a data base, which data items each are related to one or more object types, where each object type has any number (including zero) of attributes, and the method comprises
representing at least one relationship between any object type and other object types related thereto in the data base as a link attribute, which link attribute is expandable, i.e. is related to an object type having one or more further attributes;
presenting an object type and its attribute(s);
providing the user with the possibility to expand any link attribute, so that one or more further attribute(s) of the object type related to the expanded link attribute(s) is (are) presented;
providing the user with the possibility to define a view of data on the basis of the presented attribute(s); and
displaying the data items related to attribute(s) in the user defined view of data.

2. Method according to claim 1, which method further comprises the step of
providing the user with the possibility to select an object type to be presented as the root of the tree structured view.

3. A method according to claim 1, which method further comprises the step of:
displaying the attributes of an object type in an indented view.

4. A method according to claim 1, wherein the data items related to the attribute(s) are presented in a first part of a screen and wherein the attribute(s) is (are) presented to the user on a second part of the screen.

5. A method according to claim 1, wherein the method is executed by use of a database model of the database.

6. A method according to claim 1, wherein the method is performed in a personal computer, a personal digital assistant, a set-top box or in a television.

7. A method according to claim 1, wherein the method further comprises the step of providing the user with the possibility of defining a recursive view by marking a cyclic path through one or more link attributes.

8. An apparatus for performing the method of claim 1.

9. A system for performing the method of any claim 1.

10. (canceled)
